(19) United States
(12) Patent Application Publication
(10) Pub. No.: US 2026/0228523 A1
(43) Pub. Date: Aug. 6, 2026

(54) METHOD AND APPARATUS FOR QUANTIFYING SAMPLE DIFFICULTY BASED ON PRE-TRAINED MODELS

(71) Applicants: Robert Bosch GmbH, Stuttgart (DE); TSINGHUA UNIVERSITY, Beijing (CN)

(72) Inventors: Peng Cui, Beijing (CN); Dan Zhang, Beijing (CN); Jun Zhu, Beijing (CN)

(21) Appl. No.: 19/151,643

(22) PCT Filed: Apr. 6, 2023
(86) PCT No.: PCT/CN2023/086582

§ 371 Date: Jul. 29, 2025

(51) Int. Cl. G06N 3/08; G06N 3/047

(52) U.S. Cl. CPC G06N 3/08; G06N 3/047

(57) ABSTRACT

A computer implemented method for quantifying sample difficulty based on at least one pre-trained model is disclosed. The computer implemented method includes obtaining a training set for a downstream task comprising a plurality of training samples; modeling training data distributions in a feature space of the at least one pre-trained model with and without conditioning on class-related information; and quantifying a learning difficulty of each sample in the training set based at least on the training data distributions.

### FIELD

Aspects of the present invention relate generally to artificial intelligence, and more particularly, to method and apparatus provided for quantifying sample difficulty based on large-scale pre-trained models.

### BACKGROUND INFORMATION

Model training often encounters ambiguous or even distorted samples. These samples are difficult to learn from—directly enforcing the model to fit them may cause undesirable memorization and overconfidence. Due to the ambiguity of date uncertainty in the dataset collected from the open world for a downstream task, the sample difficulty quantification (i.e., characterizing the hardness and noisiness of samples) is pivotal for reliable learning of the model.

Prior works often measure the sample difficulty by only considering the task-specific data distribution and training model. As deep neural networks are prone to overfitting, they often require careful selection of training epochs, checkpoints, data splits and ensembling strategies.

Large-scale pre-training has witnessed pragmatic success in diverse scenarios and pre-trained models are becoming increasingly accessible. The community has reached the consensus that by exploiting big data, pre-trained models learn to encode rich data semantics that is promised to be generally beneficial for a broad spectrum of applications, e.g., warming up the learning on downstream tasks with limited data, improving domain generalization or model robustness, and enabling zero-shot transfer.

Thus, besides their existing applications, there is a motivation to leverage the great potential of pre-trained models to score each sample in the downstream training set according to each sample's inherent difficulty.

### SUMMARY

The following presents a simplified summary of one or more aspects of the present invention to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example embodiment of the present invention, it is disclosed herein a new use case to exploit pre-trained models to measure the difficulty of each sample in the downstream training set. Pre-trained models aid in scoring sample difficulty by shifting the problem from the raw data space to a task- and model-agnostic feature space, where simple distance measures suffice to represent similarities. Besides, large-scale multi-modal datasets and self-supervised learning principles enable the pre-trained models to generate features that sufficiently preserve high-level concepts behind the data and avoid overfitting to specific data or classes.

In light of this, according to an example embodiment of the present invention, sample difficulty estimation is provided herein to be performed in the feature space of pre-trained models and is casted as a density estimation problem since samples with typical discriminative features are easier to learn and typical features shall reappear. With the knowledge of sample difficulty learned from the pre-trained models, it is further disclosed herein to incorporate it into a variety of applications, such as data pruning, uncertainty regularization and dataset analysis, etc.

In an aspect of the present invention, a computer implemented method for quantifying sample difficulty based on at least one pre-trained model is disclosed. The computer implemented method comprises obtaining a training set for a downstream task comprising a plurality of training samples; modeling training data distributions in a feature space of the at least one pre-trained model with and without conditioning on class-related information; and quantifying a learning difficulty of each sample in the training set based at least on the training data distributions.

In a further aspect of the present invention, the modeling training data distributions in a feature space of the at least one pre-trained model with and without conditioning on class-related information comprises modeling training data distributions on an intermediate layer output of a single pre-trained model.

In a further aspect of the present invention, quantifying the learning difficulty of each sample based at least on the training data distributions comprises quantifying the learning difficulty of each sample in the training set by a difference between a distance of features of a sample to other samples from a same class and a distance of features of the sample to all other samples in the training set, based on the training data distributions.

In a further aspect of the present invention, modeling training data distributions in a feature space of the at least one pre-trained model with and without conditioning on class-related information comprises modeling training data distributions on respective intermediate layer outputs of more than one pre-trained models.

In a further aspect of the present invention, quantifying the learning difficulty of each sample based at least on the training data distributions comprises quantifying the learning difficulty of each sample in the training set on each pre-trained model by a difference between a distance of features of a sample to other samples from a same class and a distance of features of the sample to all other samples in the training set, based on the training data distributions; and ensembling the learning difficulty of each sample quantified on the more than one pre-trained models.

In a further aspect of the present invention, the distance of features of a sample to other samples from a same class and the distance of features of the sample to all other samples in the training set are evaluated by one of Mahalanobis distance, Euclidean Distance, Manhattan Distance, Cosine Distance or Hamming Distance.

In a further aspect of the present invention, the training data distributions are modeled by one or more of Gaussian distribution, Bernoulli distribution, Beta distribution, Gamma distribution, Chi-squared distribution.

In a further aspect of the present invention, the training data distributions are learned from training deep probabilistic models.

In a further aspect of the present invention, the class-related information is based on one of ground-truth labels in the case that the downstream task is in a supervised manner, or annotations and the closest class labels for samples without annotations in the case that the downstream task is in a semi-supervised manner, or indexes of the closest cluster of features for samples in the case that the downstream task is in an unsupervised manner.

In a further aspect of the present invention, the plurality of training samples is one of the types of digital image or audio signal.

In a further aspect of the present invention, the at least one pre-trained model is trained in an unsupervised manner.

In an aspect of the present invention, a computer implemented method for training a machine learning model with a training set quantified with one or more of methods disclosed herein is disclosed. The computer implemented method comprises obtaining a plurality of samples in the training set with their corresponding quantified learning difficulty; penalizing a training loss of the machine learning model with a regularization term weighted by the quantified learning difficulty of each sample; and training the machine learning model based on the penalized training loss.

In another aspect of the present invention, a computer implemented method for training a machine learning model with a training set quantified with one or more of methods disclosed herein is disclosed. The computer implemented comprises obtaining a plurality of samples in the training set with their corresponding quantified learning difficulty; processing samples with quantified learning difficulty based on a comparison between respective quantified learning difficulty and a threshold; and training the machine learning model with the processed training set.

In a further aspect of the present invention, processing samples with quantified learning difficulty based on a comparison between respective quantified learning difficulty and a threshold comprises pruning samples in the training set with quantified learning difficulty below the threshold.

In a further aspect of the present invention, processing samples with quantified learning difficulty based on a comparison between respective quantified learning difficulty and a threshold comprises grouping the training set into training subsets based on the quantified learning difficulty of each sample is above or below the threshold.

In a further aspect of the present invention, training the machine learning model with the processed training set comprises training the machine learning model with the training subset having samples with the quantified learning difficulties below the threshold; and training the machine learning model with the training subset having samples with the quantified learning difficulties above the threshold subsequently.

In an aspect of the present invention, a computer system is disclosed. The computer system comprises one or more processors; and one or more storage devices storing computer-executable instructions that, when executed, cause the one or more processors to perform the operations of one or more of the methods disclosed herein.

In an aspect of the present invention, one or more computer readable storage media storing computer-executable instructions is disclosed that, when executed, cause one or more processors to perform the operations of one or more of the methods disclosed herein.

In an aspect of the present invention, a computer program product comprising computer-executable instructions is disclosed that, when executed, cause one or more processors to perform the operations of one or more of the methods disclosed herein.

### BRIEF DESCRIPTION OF THE DRAWINGS

The disclosed aspects of the present invention will be described in connection with the figures that are provided to illustrate and not to limit the disclosed aspects.

FIG. 1A illustrates the hardest and easiest RMD-based sample, in accordance with aspects of the present invention.

FIG. 1B illustrates the RMD score variation, in accordance with aspects of the present invention.

FIG. 2 illustrates error rate achieved by ResNet34 (trained on ImageNet1k) on the validation subsets, in accordance with aspects of the present invention.

FIG. 3 illustrates an exemplary flow chart for quantifying sample difficulty based on at least one pre-trained model, in accordance with various aspects of the present invention.

FIG. 4 illustrates an exemplary flow chart for training a machine learning model with the sample difficulty used for uncertainty penalization, in accordance with aspects of the present invention.

FIG. 5 illustrates an exemplary flow chart for training a machine learning model with the sample difficulty used for data pre-processing, in accordance with aspects of the present invention.

FIG. 6 illustrates an exemplary computer system, in accordance with various aspects of the present invention.

### DETAILED DESCRIPTION OF EXAMPLE EMBODIMENTS

The present invention will now be discussed with reference to several example implementations. It is to be understood that these implementations are discussed only for enabling those skilled in the art to better understand and thus implement the embodiments of the present disclosure, rather than suggesting any limitations on the scope of the present disclosure.

Various embodiments will be described in detail with reference to the figures. Wherever possible, the same reference numbers will be used throughout the drawings to refer to the same or like parts. References made to examples and embodiments are for illustrative purposes, and are not intended to limit the scope of the disclosure.

Due to the ambiguity of date uncertainty in the dataset collected from the open world for a downstream task, the sample difficulty quantification (i.e., characterizing the hardness and noisiness of samples) is pivotal for reliable learning of the model. In an example, a low sample difficulty would imply that the sample is typical and carries class-discriminative features (close to the class-specific mean mode but far away from the class-agnostic mean mode), and furthermore, there exist many similar samples (high-density area) in the training set. Such a sample represents an easy case to learn, i.e., low quantification or score can be used to indicate low sample difficulty. It is anticipated by a skilled one in the art that the quantification or score and sample difficulty may have a reverse relation according to different computation rules, which is not limited herein.

Large-scale image and image-text data have led to high quality pre-trained vision models for downstream tasks, for example but not limited to, CLIP-ViT-B and CLIP-R50 that use ResNet-50, and ViT-B and MAE-ViT-B which use ViT-base as the image encoder. Pre-trained models aid in scoring sample difficulty by shifting the problem from the raw data space to a task- and model-agnostic feature space, where simple distance measures suffice to represent similarities, as discussed before. Besides, large-scale multi-modal datasets enable the pre-trained models to generate features that preserve high-level concepts behind the data, and moreover, self-supervised learning principles can further avoid overfitting to specific data or classes.

Inspired by this, instead of using pre-trained models as the backbone networks for downstream tasks as related arts, a new use case is proposed, i.e., scoring the sample difficulty in the training set of the downstream task based on the pre-trained models. It is disclosed herein to model the data distribution in the feature space of at least one pretrained models and derive a distance between data distribution with and without conditioning on the class-related information, in order to quantifying or scoring the sample difficulty. More details would be discussed below.

To start with, there is no rigorously defined notion of sample difficulty. Intuitively, easy-to-learn samples shall reappear in the form of showing similar patterns. Repetitive patterns specific to each class are valuable cues for classification. Moreover, they contain neither confusing nor conflicting information. Single-label images containing multiple salient objects belonging to different classes or having wrong labels would be hard samples.

To quantify the difficulty of each sample, it is proposed to model the training data distribution in the feature space of large-scale pre-trained models. In the pixel space, data distribution modeling is prone to overfitting low-level features, e.g., an outlier sample with smoother local correlation can have a higher probability than an inlier sample. On the other hand, pre-trained models are generally trained to ignore low-level information, e.g., semantic supervision from natural language or class labels. Further, in the case of self-supervised learning, the proxy task and loss are also formulated to learn a holistic understanding of the input images beyond low-level image statistics, e.g., the masking strategy designed in MAE prevents reconstruction via exploiting local correlation. Moreover, as modern pre-trained models are trained on large-scale datasets with high sample diversities in many dimensions they learn to preserve and structure richer semantic features of the training samples than models only exposed to the training set that is commonly used at a smaller scale. In the feature space of pre-trained models, it is expected that easy-to-learn samples will be closely crowded together, and hard-to-learn ones are far away from the population and even sparsely spread due to missing consistently repetitive patterns. From a data distribution perspective, the easy (hard)-to-learn samples should have high (low) probability values.

For the purpose of modeling the training data distribution in the feature space of large-scale pre-trained models, different distributions could be used. Although Gaussian distribution is used throughout as an example, it is anticipated by a skilled one in the art any suitable distribution could be applied. For example, but not limited to it, Gaussian distribution, Bernoulli distribution, Beta distribution, Gamma distribution, Chi-squared distribution, and/or the alike could be used. For another example, deep probabilistic models, such as normalizing flows, could be trained to learn the feature distributions instead of using existing distributions.

Taking supervised learning as an example by considering a downstream training set

$$𝒟 = {\{ ( {x}_{i} , {y}_{i} ) \}}_{i = 1}^{N} ,$$

which is a collection of image-label pairs, with xᵢ∈ [symbol] and yᵢ∈{1, 2, . . . , K} as the image and its label, respectively. The feature distribution of {xᵢ} is to be modeled with and without conditioning on the class information.

Let G(·) denote an intermediate layer output of the pre-trained model G. In an example, in the case of single objection detection task, the intermediate layer output of the pre-trained model would preferred to be the penultimate layer output, as the output features may be well-learned on a certain class. In another example, in the case multiple objection detection task, the intermediate layer output of the pre-trained model would preferred to be an earlier layer output, as the output features have not focused on a particular class yet.

In the example, the class-conditional distribution is modeled by fitting a Gaussian model to the feature vectors G(xᵢ) belonging to the same class yᵢ=k as below:

$$P ( G ( x ) \vert y = k ) = 𝒩 ( G ( x ) \vert {μ}_{k} , \sum ) \qquad ( 1 )$$

$${μ}_{k} = \frac{1}{{N}_{k}} {\sum }_{i : {y}_{i} = k} G ( {x}_{i} ) \qquad ( 2 )$$

$$\sum = \frac{1}{N} {\sum }_{k} {\sum }_{i : {y}_{i} = k} ( G ( {x}_{i} ) - {μ}_{k} ) {( G ( {x}_{i} ) - {μ}_{k} )}^{⊤} \qquad ( 3 )$$

wherein the mean vector μₖ is class-specific, the covariance matrix Σ is averaged over all classes to avoid under-fitting, and Nₖ denotes the number of training samples with the label yᵢ=k.

In another example, in the case of semi-supervised learning, as not all the samples in the training set have ground-truth labels, the feature can be modeled based on the samples with their corresponding annotations, and for samples without annotations, the ground-truth labels can be replaced by the closest class label.

In yet another example, in the case of fully unsupervised learning, as all the samples do not have annotations, the features can be clustered beforehand, and replace the ground-truth labels by indexes of the closest cluster. And then derive cluster-conditional distributions rather than class-conditional distributions.

In addition to the class-conditional distribution, the class-agnostic distribution is obtained by fitting to all feature vectors regardless of their classes as below:

$$P ( G ( x ) ) = 𝒩 ( G ( x ) \vert {μ}_{agn} , {\sum }_{agn} ) \qquad ( 4 )$$

$${μ}_{agn} = \frac{1}{N} {\sum }_{i}^{N} G ( {x}_{i} ) \qquad ( 5 )$$

$${\sum }_{agn} = \frac{1}{N} {\sum }_{i}^{N} ( G ( {x}_{i} ) - {μ}_{agn} ) {( G ( {x}_{i} ) - {μ}_{agn} )}^{⊤} \qquad ( 6 )$$

For scoring sample difficulty, it is proposed to quantifying a learning difficulty of each sample in the training set based on a difference between a distance of features of a sample to other samples from a same class and a distance of features of the sample to all other samples in the training set, based on the training data distributions. Although relative Mahalanobis distances is used throughout as an example, it is anticipated by a skilled one in the art any suitable approach could be applied. For example, but not limited to, Euclidean Distance, Manhattan Distance, Cosine Distance, Hamming Distance and/or the alike can be used.

In an example, the difference between the Mahalanobis distances respectively induced by the class-specific and class-agnostic Gaussian distribution in (1) and (4) is used to evaluate the distance between the training data distributions modeled with and without conditioning on class-related information, and boiling down to:

$$ℛℳ ( {x}_{i} , {y}_{i} ) = ℳ ( {x}_{i} , {y}_{i} ) - {ℳ}_{agn} ( {x}_{i} ) \qquad ( 7 )$$

$$ℳ ( {x}_{i} , {y}_{i} ) = - {( G ( {x}_{i} ) - {μ}_{{y}_{i}} )}^{⊤} {\sum }^{- 1} ( G ( {x}_{i} ) - {μ}_{{y}_{i}} ) \qquad ( 8 )$$

$${ℳ}_{agn} ( {x}_{i} ) = - {( G ( {x}_{i} ) - {μ}_{agn} )}^{⊤} {\sum }_{agn}^{- 1} ( G ( {x}_{i} ) - {μ}_{agn} ) \qquad ( 9 )$$

A small class-conditional MD [symbol] (xᵢ,yᵢ) indicates that the sample exhibits typical features of the sub-population (training samples from the same class). However, some features may not be unique to the sub-population, i.e., common features across classes, yielding a small class-agnostic MD [symbol] _{agn}(xᵢ). Since discriminative features are more valuable for classification, an easier-to-learn sample should have small class-conditional MD but large class-agnostic MD. The derived RMD is thus an improvement over the class-conditional MD for measuring the sample difficulty, especially when pre-trained models that have no direct supervision for downstream classification are used.

In an example, each of the training sample is fed into a single pre-trained model, such as CLIP, and the output is collected, which can be a feature map or vector, and used to evaluate the sample difficulty as (1)-(9). In another example, each of the training sample is fed into more than one pre-trained models, which can be same type or different types of pre-trained models, and the sample difficulty derived from each pre-trained model can be ensembled to obtain a final sample difficulty score. It is anticipated for a skilled one in the art that any suitable ensemble approach can be used.

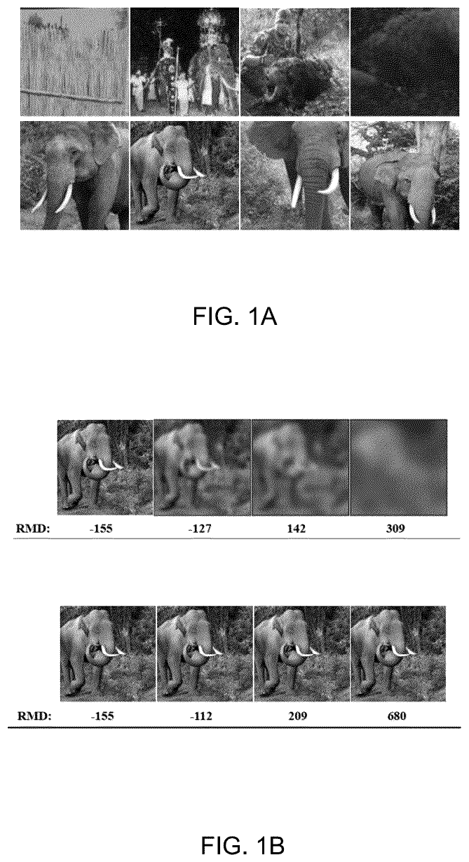

FIG. 1A illustrates the hardest and easiest RMD-based sample, in accordance with aspects of the disclosure. As shown, hard samples (upper row) tend to be challenging to classify, as they miss the relevant information or contain ambiguous information, while easy samples (lower row) appear to be easily classified as they possess obvious discriminative features. FIG. 1 shows a high-level agreement between human visual perception and RMD-based sample difficulty.

FIG. 1B illustrates the RMD score variation, in accordance with aspects of the disclosure. The sample difficulty is manipulated by corrupting the input image or alternating the label, and correspondingly upper row of FIG. 1B shows that the RMD score increases proportionally with the severity of corruption, and lower row of FIG. 1B shows that the RMD score increases proportionally with the severity of label noise (the last three images are annotated with wrong labels), which further shows the effectiveness of RMD in characterizing the hardness and noisiness of samples.

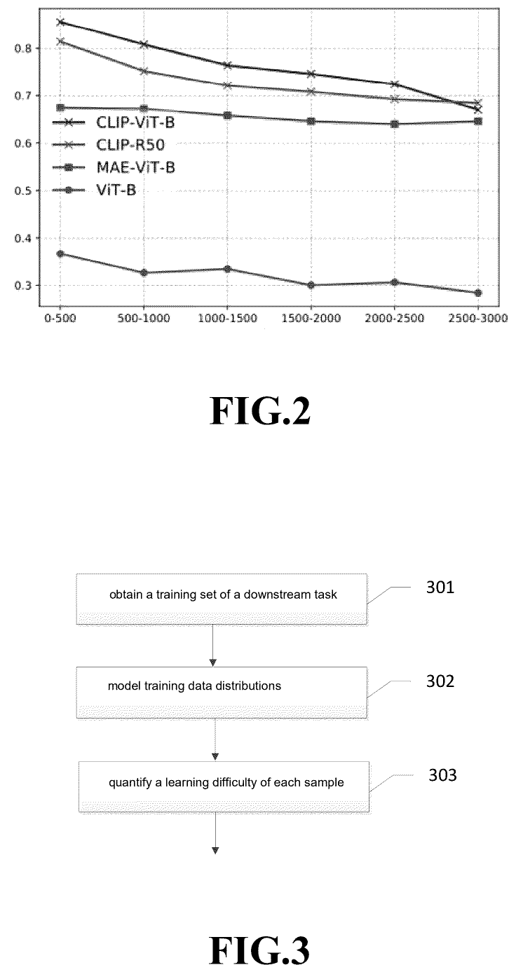

As there is no ground-truth annotation of sample difficulty, a proxy test for quantitative evaluation is constructed. Hard samples are more likely to be misclassified, therefore RMD is used to sort each ImageNet1k validation sample in the descending order of the sample difficulty and group them into subsets of equal size. FIG. 2 shows that an off-the-shelf ImageNet1k classifier (ResNet34 and standard training procedure) performed worst on the hardest data split, and its performance gradually improves as the data split difficulty reduces. This observation indicates an agreement between ResNet34 and RMD regarding what samples are hard and easy.

With the knowledge of sample difficulty of each sample, it could be used for a variety of tasks. In an example, a training loss can be penalized by a regularization weighted by the sample difficulty, in order to penalize confident predictions on hard samples. In another example, training set can be pruned by pruning easy samples to improve training efficiency and avoid overfitting. In yet another example, training set can be grouped into different subsets with easy samples and hard samples respectively, so the model can start with learning from easy samples first and then learning from hard ones, which would help training process and final results.

FIG. 2 illustrates error rate achieved by ResNet34 (trained on ImageNet1k) on the validation subsets, in accordance with aspects of the disclosure. Each validation subset contains 500 samples ranked from ath to bth hardest. Four different pre-trained models, CLIP-ViT-B, CLIP-R50, MAE-ViT-B and ViT-B, are used for computing RMDs and ranking. As shown in FIG. 2, they all show the same trend, i.e., the error rate reduces along with the sample difficulty. However, ViT-B supervisedly trained on ImageNet21k performed much worse than the others. Particularly, MAE-ViT-B (which is only trained on ImageNet1k) performs significantly better than ViT-B (trained on ImageNet21k). Thus, it reveals that self-supervised learning (MAE-ViT-B) plays a positive role compared to supervised learning (ViT-B), as it does not overfit the training classes and instead learn a holistic understanding of the input images beyond low-level image statistics aided by a well-designed loss.

FIG. 3 illustrates an exemplary flow chart for quantifying sample difficulty based on at least one pre-trained model, in accordance with various aspects of the present disclosure. As described below, some or all illustrated features may be omitted in a particular implementation within the scope of the present disclosure, and some illustrated features may not be required for implementation of all embodiments. Further, some of the blocks may be performed parallel or in a different order. In some examples, the method may be carried out by any suitable apparatus or means for carrying out the functions or algorithm described below.

The disclosed method of quantifying sample difficulty of each sample in a training set for a downstream task, which could be used for deal with the data to be trained in order to improve training efficiency, ameliorating model reliability, and avoid overfitting. The downstream task would across a variety of scenarios, to name a few, object detection, anomaly detection, selective classification, and active learning, etc.

The disclosed method of quantifying sample difficulty of each sample in a training set is suitable for processing a wide range of training samples, particularly suitable for digital images and/or audio signals obtained from sensors. The above is merely examples for embodiments of the disclosure without limiting it.

Now the disclosed method of quantifying sample difficulty based on at least one pre-trained model is illustrated with FIG. 3. The method begins at block 301, with obtaining a training set for a downstream task comprising a plurality of training samples.

In an example, the at least one pre-trained models are trained in an unsupervised manner.

In an example, the downstream task could be one of object detection, anomaly detection, selective classification, and active learning, etc., or any suitable type of task.

In an example, the plurality of training samples is one of the types of digital image, such as video, radar images, LiDAR images, ultrasonic images, motion images and thermal images, or audio signal, or any other type of data or signal captured by at least one of sensor(s), camera(s) or scanner(s).

In an example, the sample difficulty is quantified based on one pre-trained model. In another example, the sample difficulty is quantified based on more than one pre-trained models.

The method proceeds to block 302, with modeling training data distributions in a feature space of the at least one pre-trained model with and without conditioning on class-related information.

In an example, in the case of the sample difficulty of each sample is quantified based on a single pre-trained model, training data distributions are modeled on an intermediate layer output of the single pre-trained model with and without conditioning on class-related information.

In a further example, training data distribution can be modeled by one of Gaussian distribution, Bernoulli distribution, Beta distribution, Gamma distribution, Chi-squared distribution, and/or the alike. In another further example, the training data distributions are learned from training deep probabilistic models.

In a further example, training data distribution can be modeled on the penultimate layer output of the single pre-trained model. In another further example, training data distribution can be modeled on an earlier layer output of the single pre-trained model.

In a further example, in the case of the downstream task would be in a supervised learning manner, the class-related information can be based on ground-truth labels. In another further example, in the case of the downstream task would be in a semi-supervised manner, the class-related information can be based on annotations and the closest class labels for samples without annotations. In yet another further example, in the case of the downstream task would be in an unsupervised manner, the class-related information can be based on indexes of the closest cluster of features for samples.

In a further example, training data distributions with and without conditioning on class-related information can be modeled on the single pre-trained model by Gaussian distribution as described with Eq. (1)-(6).

In another example, in the case of the sample difficulty of each sample is quantified based on more than one pre-trained models, the operation of modeling training data distributions in feature spaces of more than one pre-trained model can be performed in a similar way as the operation of modeling training data distributions in a feature space of a single pre-trained model respectively.

The method then proceeds to block 303, with quantifying a learning difficulty of each sample in the training set based at least on the training data distributions.

In an example, in the case of the sample difficulty of each sample is quantified based on a single pre-trained model, the learning difficulty of each sample in the training set is quantified by a difference between a distance of features of a sample to other samples from a same class and a distance of features of the sample to all other samples in the training set, based on the training data distributions.

In a further example, the distance of features of a sample to other samples from a same class and the distance of features of the sample to all other samples in the training set are evaluated by Mahalanobis distance. Therefore, the difference between the two distances is evaluated by a relative Mahalanobis distance.

In a further example, the learning difficulty of each sample in the training set is quantified as described with Eq. (7)-(9).

In another example, in the case of the sample difficulty of each sample is quantified based on more than one pre-trained models, the operation of quantifying a learning difficulty of each sample in the training set based at least on the training data distributions modeled on more than one pre-trained models can be performed in a similar way as the operation of quantifying a learning difficulty of each sample in the training set based at least on the training data distributions modeled on a single pre-trained model respectively.

In a further example, quantification of the learning difficulties of each sample from more than one pre-trained models can be ensembled to obtain a final learning difficulty for that sample. The learning difficulties can be ensembled by any suitable approach, such as bagging, boosting, blending or stacking and/or the alike.

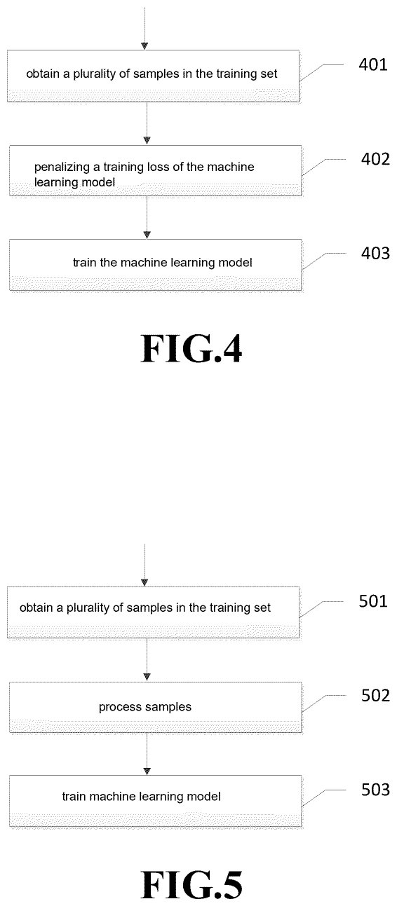

With the knowledge of the sample difficulty quantified based on the pre-trained models, FIG. 4 illustrates an exemplary flow chart for training a machine learning model with the sample difficulty used for uncertainty penalization, in accordance with aspects of the disclosure. As described below, some or all illustrated features may be omitted in a particular implementation within the scope of the present disclosure, and some illustrated features may not be required for implementation of all embodiments. Further, some of the blocks may be performed parallel or in a different order. In some examples, the method may be carried out by any suitable apparatus or means for carrying out the functions or algorithm described below.

The method can be performed subsequent to block 303 and proceeds to block 401, with obtaining a plurality of samples in the training set with their corresponding quantified learning difficulty, wherein the quantified learning difficulty is obtained by method described with FIG. 3.

The method then proceeds to block 402, with penalizing a training loss of the machine learning model with a regularization term weighted by the quantified learning difficulty of each sample. The machine learning model is to perform the downstream task as described with FIG. 3.

The method then proceeds to block 403, with training the machine learning model based on the penalized training loss. In this approach, the main terms of the training loss of the machine learning model need not to be changed, it is only needed to add sample difficulty aware coefficients to the regularization term. The overconfident predictions can be penalized as a larger sample difficulty would imply a hard-to-learn sample.

With the knowledge of the sample difficulty quantified based on the pre-trained models, FIG. 5 illustrates an exemplary flow chart for training a machine learning model with the sample difficulty used for data pre-processing, in accordance with aspects of the disclosure. As described below, some or all illustrated features may be omitted in a particular implementation within the scope of the present disclosure, and some illustrated features may not be required for implementation of all embodiments. Further, some of the blocks may be performed parallel or in a different order. In some examples, the method may be carried out by any suitable apparatus or means for carrying out the functions or algorithm described below.

The method can be performed subsequent to block 303 and proceeds to block 501, with obtaining a plurality of samples in the training set with their corresponding quantified learning difficulty. The machine learning model is to perform the downstream task as described with FIG. 3.

The method then proceeds to block 502, with processing samples with quantified learning difficulty based on a comparison between respective quantified learning difficulty and a threshold.

In an example, the processing comprises pruning samples in the training set with quantified learning difficulty below the threshold. As lower sample difficulty would indicate easy-to-learn samples, so it is preferred that a training set is composed of appropriate quantity of them, too many easy samples may potentially result in overfitting.

In another example, the processing comprises grouping the training set into training subsets based on the quantified learning difficulty of each sample is above or below the threshold.

The method then proceeds to block 503, with training the machine learning model with the processed training set.

In an example, training the machine learning model comprises training the machine learning model with the training subset having samples with the quantified learning difficulties below the threshold; and training the machine learning model with the training subset having samples with the quantified learning difficulties above the threshold subsequently. It would help the training and final results if start with easy samples.

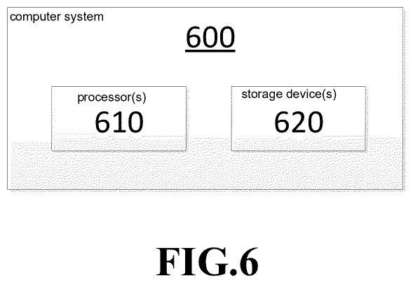

FIG. 6 illustrates an exemplary computer system 600, in accordance with various aspects of the present disclosure. The computer system may comprise at least one processor 610. The computer system may further comprise at least one storage device 620. It should be appreciated that the storage device 620 may store computer-executable instructions that, when executed, cause the processor 610 to perform any operations according to the embodiments of the present disclosure as described in connection with FIGS. 1A-5.

The embodiments of the present disclosure may be embodied in one or more computer-readable medium such as non-transitory computer-readable medium. The non-transitory computer-readable medium may store instructions that, when executed, cause one or more processors to perform any operations according to the embodiments of the present disclosure as described in connection with FIGS. 1A-5.

The embodiments of the present disclosure may be embodied in a computer program product comprising computer-executable instructions that, when executed, cause one or more processors to perform any operations according to the embodiments of the present disclosure as described in connection with FIGS. 1A-5.

It should be appreciated that all the operations in the methods described above are merely exemplary, and the present disclosure is not limited to any operations in the methods or sequence orders of these operations, and should cover all other equivalents under the same or similar concepts.

It should also be appreciated that all the modules in the apparatuses described above may be implemented in various approaches. These modules may be implemented as hardware, software, or a combination thereof. Moreover, any of these modules may be further functionally divided into sub-modules or combined together.

The above description is provided to enable any person skilled in the art to practice the various aspects of the present invention described herein. Various modifications to these aspects will be readily apparent to those skilled in the art, and the generic principles defined herein may be applied to other aspects. Thus, the present invention is not intended to be limited to the aspects shown herein. All structural and functional equivalents to the elements of the various aspects described throughout the present disclosure that are known or later come to be known to those of ordinary skill in the art are expressly incorporated herein by reference and are intended to be encompassed by the present invention.

1-19. (canceled)

20. A computer implemented method for quantifying sample difficulty based on at least one pre-trained model, comprising the following steps:
obtaining a training set for a downstream task, the training set including a plurality of training samples;
modeling training data distributions in a feature space of the at least one pre-trained model with and without conditioning on class-related information; and
quantifying a learning difficulty of each sample in the training set based at least on the training data distributions.

21. The computer implemented method of claim 20, wherein modeling training data distributions in the feature space of the at least one pre-trained model with and without conditioning on class-related information includes:
modeling training data distributions on an intermediate layer output of a single pre-trained model.

22. The computer implemented method of claim 21, wherein the quantifying the learning difficulty of each sample based at least on the training data distributions includes:
quantifying the learning difficulty of each sample in the training set by a difference between a distance of features of a sample to other samples from a same class and a distance of features of the sample to all other samples in the training set, based on the training data distributions.

23. The computer implemented method of claim 20, wherein the modeling training data distributions in the feature space of the at least one pre-trained model with and without conditioning on class-related information including:
modeling training data distributions on respective intermediate layer outputs of more than one pre-trained models.

24. The computer implemented method of claim 23, wherein the quantifying the learning difficulty of each sample based at least on the training data distributions includes:
quantifying the learning difficulty of each sample in the training set on each pre-trained model by a difference between a distance of features of a sample to other samples from a same class and a distance of features of the sample to all other samples in the training set, based on the training data distributions; and
ensembling the learning difficulty of each sample quantified on the more than one pre-trained models.

25. The computer implemented method of claim 22, wherein the distance of features of a sample to other samples from a same class and the distance of features of the sample to all other samples in the training set are evaluated by one of Mahalanobis distance or Euclidean Distance or Manhattan Distance or Cosine Distance or Hamming Distance.

26. The computer implemented method of claim 22, wherein the training data distributions are modeled by one or more of Gaussian distribution, Bernoulli distribution, Beta distribution, Gamma distribution, Chi-squared distribution.

27. The computer implemented method of claim 20, wherein the training data distributions are learned from training deep probabilistic models.

28. The computer implemented method of claim 20, wherein the class-related information is based on one of:
ground-truth labels in the case that the downstream task is in a supervised manner, or
annotations and closest class labels for samples without annotations in the case that the downstream task is in a semi-supervised manner, or
indexes of closest cluster of features for samples in the case that the downstream task is in an unsupervised manner.

29. The computer implemented method of claim 20, wherein the plurality of training samples is one of the types of digital image or audio signal.

30. The computer implemented method of claim 20, wherein the at least one pre-trained model is trained in an unsupervised manner.

31. The computer implemented method of claim 20, further comprising:
training a machine learning model with the training set, including:
obtaining a plurality of samples in the training set with their quantified learning difficulty,
penalizing a training loss of the machine learning model with a regularization term weighted by the quantified learning difficulty of each sample, and
training the machine learning model based on the penalized training loss.

32. The computer implemented method of claim 20, further comprising:
training a machine learning model with the training set, including:
obtaining a plurality of samples in the training set with their quantified learning difficulty,
processing samples with quantified learning difficulty based on a comparison between the respective quantified learning difficulty and a threshold, and
training the machine learning model with the processed training set.

33. The computer implemented method of claim 32, wherein the processing of the samples with quantified learning difficulty based on a comparison between the respective quantified learning difficulty and a threshold includes:
pruning samples in the training set with quantified learning difficulty below the threshold.

34. The computer implemented method of claim 32, wherein the processing of the samples with quantified learning difficulty based on a comparison between respective quantified learning difficulty and a threshold includes:
grouping the training set into training subsets based on the quantified learning difficulty of each sample is above or below the threshold.

35. The computer implemented method of claim 34, wherein the training of the machine learning model with the processed training set includes:
training the machine learning model with the training subset having samples with the quantified learning difficulties below the threshold; and
training the machine learning model with the training subset having samples with the quantified learning difficulties above the threshold subsequently.

36. A computer system, comprising:
one or more processors; and
one or more storage devices storing computer-executable instructions that, when executed, cause the one or more processors to perform a method for quantifying sample difficulty based on at least one pre-trained model, the method including the following steps:
obtaining a training set for a downstream task, the training set including a plurality of training samples,
modeling training data distributions in a feature space of the at least one pre-trained model with and without conditioning on class-related information, and
quantifying a learning difficulty of each sample in the training set based at least on the training data distributions.

37. One or more non-transitory computer readable storage media on which are stored computer-executable instructions for quantifying sample difficulty based on at least one pre-trained model, the instructions, when executed by one or more processors, causing the one or more processors to perform the following steps:
obtaining a training set for a downstream task, the training set including a plurality of training samples;
modeling training data distributions in a feature space of the at least one pre-trained model with and without conditioning on class-related information; and
quantifying a learning difficulty of each sample in the training set based at least on the training data distributions.
